(19) United States
(12) Patent Application Publication
(10) Pub. No.: US 2010/0285244 A1
(43) Pub. Date: Nov. 11, 2010

(54) ACRYLIC PRESSURE SENSITIVE ADHESIVE COMPOSITIONS

(76) Inventor: Dong Han Kho, Daegu (KR)

Correspondence Address: MCKENNA LONG & ALDRIDGE LLP, 1900 K STREET, NW, WASHINGTON, DC, 20006, US

(21) Appl. No.: 12/448,918

(22) PCT Filed: Oct. 17, 2007
(86) PCT No.: PCT/KR2007/005077

§ 371 Date: Dec. 31, 2009

(30) Foreign Application Priority Data
Jan. 18, 2007 (KR) 10-2007-0005741

(51) Int. Cl. C09K 19/52; C08L 33/08; C08L 71/02; B32B 7/02; C08F 8/30; C08F 8/00; C08K 5/101

(52) U.S. Cl. 428/1.54; 524/560; 525/187; 428/216; 525/330.3; 525/330.5; 525/330.6; 524/300

(57) ABSTRACT

The present invention relates to an acrylic pressure sensitive adhesive composition. More specifically, the present invention relates to an acrylic pressure sensitive adhesive composition which comprises a) acrylic copolymers; and b) a compound having an ester value of 200 or more. The acrylic pressure sensitive adhesive composition of the present invention has an excellent wettability to the surface of an adhered article with surface unevenness, an excellent endurance reliability, transparency, and stain resistance of adhered article, and a high-rate release property without any considerable change of adhesive properties.

TECHNICAL FIELD

The present invention relates to an acrylic pressure sensitive adhesive composition. More specifically, the present invention relates to an acrylic pressure-sensitive adhesive composition comprising a) acrylic copolymers; and b) a compound having an ester value of 200 or more. The present composition has an excellent wettability to the surface of an adhered article with surface unevenness, has an excellent endurance reliability, transparency, and stain resistance of adhered article, and has a high-rate release property.

### BACKGROUND ART

Recently, due to increased demand of liquid crystal display devices, demand of films with optical properties such as polarizers is also rapidly increased. Therefore, it is required to practice production processes of liquid crystal display devices at high speed. In addition, main liquid crystal display manufacturers have been focusing on producing small panels having a size of 20 inch or less. However, they are now rapidly enlarging product ranges in a large size of 20 inch or more by actively utilizing new technologies. Sizes of polarizers used on producing liquid crystal display devices are also enlarged as a liquid crystal display becomes larger, whereas release speeds of protective films adhered to the polarizers are also more increased than the existing speed as processes are practiced at high speed.

The protective films of polarizers serve as protection of polarizers to foreign substances, or wounds such as scratches which may occur in the display assembly process and are removed by releasing them in a detection process of panels

Recently, surface treatments of polarizers are carried out by various methods. The surface treatments of polarizers include an antiglare layer, a low refractive layer and/or a high refractive layer, or an anti-staining layer, each of which has different surface roughness and surface energy. Especially, the antiglare layer has higher surface roughness and lower surface energy than a triacetyl cellulose layer, so that a large quantity of bubbles are generated in an autoclave process by incorporating fine bubbles on adhering the protective film, and thus defects are mused. Therefore, the wet property of pressure sensitive adhesives for protective films is important.

In order to easily perform such release at high speed as above, JP Unexamined Patent Publication No. 2005-146151 discloses a pressure sensitive adhesive composition with a good high-rate release property, obtained by mixing an acrylic polymer having a glass transition temperature of −40° C. or less and an acrylic polymer having a glass transition temperature of 80° C. or more. However, the glass transition temperature of adhesive resin in the above method may be raised to affect the wettability property of antiglare layer adversely.

Meanwhile, in JP Unexamined Patent Publication No. 2005-023143, releasability at high speed was given by adding a phosphoric ester of polyoxy alkylene alkyl ether to an acrylic ester copolymer, but said additive changed adhesion properties to cause the reduced low-rate release strength.

### DISCLOSURE OF INVENTION

### Technical Problem

The present invention is intended to solve problems of the prior art. One object of the present invention is to provide an acrylic pressure-sensitive adhesive composition having an excellent wettability to the surface of an adhered article with surface unevenness, having an excellent endurance reliability, transparency, and stain resistance of adhered article, and having a high-rate release property, without any considerable change of adhesion properties.

Another object of the present invention is to provide a protective film, comprising the acrylic pressure sensitive adhesive composition having said excellent physical properties.

The other object of the present invention is to provide a polarizer and a liquid crystal display device, on which said protective film is applied.

### Technical Solution

In order to achieve these objects, the present invention provides an acrylic; pressure sensitive adhesive composition comprising:

a) acrylic copolymers; and

b) a compound having an ester value of 200 or more.

The present invention also provides a protective film comprising:

a substrate; and

an adhesive layer comprising the acrylic pressure sensitive adhesive composition of the present invention, wherein the adhesive layer is formed on one side or both sides of the substrate.

This present invention also provides a polarizer including the above protective film; and a liquid crystal display device comprising a liquid crystal panel in which the above polarizer is adhered onto one side or both sides of the liquid crystal cell.

### BEST MODE FOR CARRYING OUT THE INVENTION

Hereinafter, the present invention will be described in more detail.

The present inventors found out that an excellent wettability to the surface of an adhered article with surface unevenness, an excellent endurance reliability, transparency, and stain resistance of an adhered article, and a high-rate release property can be provided, without any considerable change of adhesion properties, by applying acrylic pressure sensitive adhesive on a protective film, wherein the acrylic pressure sensitive adhesive comprises a compound having an ester value of 200 or more which has excellent good compatibility with acrylic pressure sensitive adhesive.

Therefore, the acrylic pressure sensitive adhesive composition according to the present invention is characterized in comprising, a) acrylic copolymers; and b) a compound having an ester value of 200 or more. The preferable content of the compound having an ester value of 200 or more is 0.5 to 10 parts by weight based on 100 parts by weight of the acrylic copolymers. When the content of the compound is less than 0.5 parts by weight, the wettability to the surface of an adhered article is decreased, and when the content of the compound is more than 10 parts by weight, adhesion properties are decreased, so that it is not corresponding to the objects of the present invention.

The acrylic copolymers of the above a) used in the present invention are not limited if they can be used as pressure sensitive adhesive in the art, but it is preferable that the acrylic copolymers comprise

i) 90-99.9 parts by weight of (meth)acrylic acid ester monomers having alkyl group of 1-12 carbon atoms; and

ii) 0.1 to 10 parts by weight of vinyl monomers, and/or acrylic monomers having cross-linkable functional groups.

As the above (meth)acrylic add ester monomers having alkyl group of 1-12 carbon atoms of the above i), there may be methyl (meth)acrylate, ethyl (meth)acrylate, n-propyl (meth)acrylate, isopropyl (meth)acrylate, n-butyl (meth)acrylate, t-butyl (meth)acrylate, sec-butyl (meth)acrylate, pentyl (meth)acrylate, 2-ethylbutyl (meth)acrylate, 2-ethylhexyl (meth)acrylate, n-octyl (meth)acrylate, isooctyl (meth)acrylate, isononyl (meth)acrylate, or the mixture thereof.

The preferable content of the above (meth)acrylic aid ester monomers having alkyl group of 1-12 carbon atoms is 90-99.9 parts by weight. When the content is less than 90 parts by weight, the linkage density may increase to lower the wettability. When the content is more than 99.9 parts by weight, the cohesive strength gets decreased so that the endurance reliability may be decreased.

The vinyl monomers and/or acrylic monomers having cross-linkable functional groups in the above ii) react with crosslinking agent and play a role to provide cohesive strength and adhesive strength by chemical bond in order to prevent destruction of cohesive strength of the pressure sensitive adhesive under high temperature or humidity condition.

As the vinyl monomers and/or acrylic monomers having cross-linkable functional groups, monomers having hydroxyl group such as 2-hydroxyethyl (meth)acrylate, 2-hydroxypropyl (meth)acrylate, 4-hydroxybutyl (meth)acrylate, 6-hydroxyhexyl (meth)acrylate, 2-hydroxyethyleneglycol(meth)acrylate, or 2-hydroxypropyleneglycol(meth)acrylate; monomer having carboxylic group such as (meth)acrylic aid, maleic acid, or fumaric acid; or monomer having nitrogen atom such as acryl amide, N-vinyl pyrrolidone, or N-vinyl caprolactam; etc, may be used alone or in mixture thereof.

Among the acrylic copolymers, the preferable content of vinyl monomers and/or acryl's monomers having cross-linkable functional groups is 0.1 to 10 parts by weight. When the content is less than 0.1 parts by weight, the destruction of cohesiveness may be easily occurred under high temperature or humidity condition. And, when the content is more than 10 parts by weight, the fluidity may be decreased due to low compatibility.

Also, it is preferable that the present invention comprises comonomer as an optional component to control glass transition temperature of adhesives or give other functions during the producing of the acrylic copolymers.

As the comonomer above, any conventional monomer having vinyl group may be used as long as the acrylic adhesive resins having −130-50° C. of glass transition temperature in the non-crosslinked state, but it is preferable to use the vinyl monomer of the following formula (1):

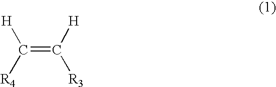

wherein,

R4 represents hydrogen or alkyl,

R3 represents cyano, phenyl unsubstituted or substituted with alkyl, acetyloxy, or COR5, wherein R5 represents amino, or glycidyloxy unsubstituted or substituted with alkyl.

The preferable example of the above functional monomers is not specifically limited, and may includes acrylonitrile, (meth)acryl amide, n-methyl acryl amide, styrene, methyl styrene, glycidyl (meth)acrylate, and vinyl acetate, or mixture thereof.

The acrylic copolymer comprising the above components can be prepared by conventional methods such as solution polymerization, photo-polymerization, bulk polymerization, suspension polymerization, and emulsion polymerization, particularly solution polymerization is preferable. Here, it is preferable to set the polymerization temperature between 50-140° C., and to add an initiator after monomers are evenly mixed.

The additive of the above b) of the present invention is a compound having an ester value of 200 or more. The ester value can be defined by the number of milligrams of potassium hydroxide needed to saponify the ester included in one gram of a sample completely. When acrylic copolymer is mixed with the compound having an ester value of 200 or more, the adhesive properties of the acrylic copolymer are not changed, because the compounds hardly migrates to the surface of adhesion article due to the excellent compatibility. In addition, the compounds can soften the acrylic; copolymer to provide an excellent wettability, even if it adheres to an adhesion article having high surface roughness. Thus, the compounds can decrease the incorporating of fine bubbles remarkably.

For the compositions of the present invention, the compound can be used without limitation as long as it has an ester value of 200 or more. The representative compound may include plasticizer, such as dibutyl phthalate (DBP, ester value of 400˜406), trioctyl trimellitate (TOTM, ester value of 303˜311), bis-(2-butoxyethyl) phthalate (DBEP, ester value of 301˜311), commercial name of D950 (J Plus Co., Ltd. of Japan, DBEP+other components, ester value of 289˜299), diisononyl adipic acid (DINA, ester value of 276˜284), bis-(2-butoxyethyl) adipic acid) (ester value of 320˜330), or acetyl tributyl citrate (ATBC, ester value of 552˜560).

The acrylic pressure sensitive adhesive composition of the present invention may further comprise a crosslinking agent.

The adhesive characteristic of pressure sensitive adhesive may be controlled depending on the content of the crosslinking agent, and the crosslinking agent has a function to increase cohesion of the pressure sensitive adhesive by reacting with carboxyl or hydroxyl.

The crosslinking agent can be selected from isocyanates, epoxys, aziridines, or metal chelates, etc, and particularly isocyanates are preferred.

Specifically, the isocyanate crosslinking agent may be tolylene diisocyanate, xylene diisocyanate, diphenylmethane diisocyanate, hexamethylene diisocyanate, isoform diisocyanate, tetramethylxylene diisocyanate, naphthalene diisocyanate, or their reactants with polyol like trimethylolpropane.

The epoxy crosslinking agent may be ethyleneglycol diglycidylether, triglycidylether, trimethylolpropane triglycidylether, N,N,N′N′-tetraglycidylethylenediamine, or glycerine diglycidylether.

The aziridine crosslinking agent may be N,N′-toluene-2,4-bis(1-aziridinecarboxide), N,N′-diphenylmethane-4,4′-bis(1-aziridinecarboxide), triethylenemelamine, bisisoprotaloyl-1-(2-methylaziridine), or tri-1-aziridinylphosphineoxide.

For the metal chelate crosslinking agent, compounds prepared by coordinating multivalent metal such as Al, Fe, Zn, Sn, Ti, Sb, Mg, and V with acethylacetone or ethyl acetoacetate can be used.

The preferable content of the crosslinking agent is 0. 1 to 10 parts by weight based on the 100 parts by weight of the acrylic copolymers. When the content is less than 0.1 parts by weight, the high-rate release property may be decreased due to insufficient cohesive strength. And, when the content is more than 10 parts by weight, the wettability of an adhered article may be remarkably decreased due to the decreased adhesive property.

In addition, the acrylic pressure sensitive adhesive composition of the present invention, if necessary, may further include tackfiers, acrylic low molecular weight substances, epoxy resins, curing agents, UV stabilizers, antioxidants, coloring agents, reinforcing agents, fillers, antifoaming agents, blowing agents, or organic salts.

The preparation method of the pressure sensitive adhesive composition of the present invention having the above components is not specifically limited. At this time, in the mixing process to form the pressure sensitive adhesive layer, a crosslinking reaction of functional groups of a crosslinking agent should not cur for even coating. After the coating followed by drying and aging, a crosslinking structure is formed, thereby obtaining a pressure sensitive adhesive layer having elasticity and strong cohesive strength. Here, by the strong cohesive strength of pressure sensitive adhesive, the pressure sensitive adhesive property such as endurance reliability of a pressure sensitive adhesive product and the cutting characteristic are enhanced.

The proper crosslinking density of the acrylic pressure sensitive adhesive composition of the present invention is 90% or more. When the crosslinking density of the pressure sensitive adhesive is less than 90%, the high-rate release property is reduced.

The present invention also relates a protective film comprising:

a substrate; and

an adhesive layer comprising the acrylic pressure sensitive adhesive composition of the present invention, wherein the adhesive layer is formed on one side or both sides of the substrate.

The above protective film is an optical film, preferably consists of a substrate and an adhesive layer as a layer protecting the surface of a polarizer.

The above substrate film is not specifically limited. For example, polyester film having transparency such as cellulose, polycarbonate, or polyethylene terephthalate; polyether film such as polyether sulfone; or polyolefin film such as polyethylene, polypropylene, polyolefin having a structure of cyclo or norbornene, or ethylene propylene copolymer; and etc., may be used.

The above transparent substrate film may have a single or two or more laminated layers, and the thickness of the substrate film may be varied depending on purposes, but the preferable thickness is 5-500 μm, and more preferable thickness is 10-100 μm.

Also, the transparent substrate film may be treated with surface treatment or primer treatment on one side or both sides to enhance the adherent property between substrate and pressure sensitive adhesive layer, and may further include antistatic layer or anti-staining layer.

The above method of forming the pressure sensitive adhesive layer on the substrate film is not limited. For example, the method may comprise the steps of coating the pressure sensitive adhesive directly on the surface of a substrate film with a bar coater and then drying it. Or, the method may comprise the steps of coating the pressure sensitive adhesive on the surface of a dissecting substrate followed by drying, and then transferring the pressure sensitive adhesive layer onto the surface of a substrate film, followed by aging. At this time, the preferable thickness of laminated adhesive layer is 2-100 μm, and the more preferable thickness is 5-50 μm. When the thickness of laminated adhesive layer is out of the above range, the properties of the adhesive film may be uneven since it is difficult to prepare even adhesive layer.

The present invention also relates to a polarizer comprising:

a polarizing film or a polarizing device; and

the protective film of the present invention.

A polarizing film or a polarizing device forming the above polarizer is not specifically limited. For example, the polarizing film prepared by adding a polarizing component such as iodine or dichroic dye onto polyvinyl alcohol resin film and elongating it may be used. Also, there is no limitation in the thickness of a polarizing film, and so the film may be made in conventional thickness. As a polyvinyl alcohol resin, polyvinyl alcohol, polyvinyl formal, polyvinyl acetal and ethylene, saponified vinyl acetate copolymer, etc., can be used.

On both sides of the polarizing film, multilayer films may be formed. The multilayer films are made by laminated protective films such as cellulose films like triacetyl cellulose, etc.; polyester films like polycarbonate film, polyethylene terephthalate, etc.; poly ether sulphone films; poly olefin films having the stricture of polyethylene or polypropylene, and polyolefine films having cyclo or norbornene structure, or ethylene propylene copolymer. The thickness of such protective films is not limited specifically, and conventional thickness may be accepted.

The polarizer of the present invention can include one or more additional layers providing supplementary functions, such as protective layer, reflecting layer, antiglare film, phase retardation film, compensation film for wide view angle, and brightness enhancing film. And the protective film according to the present invention may be applied to the above functional layers.

In addition, the acrylic pressure sensitive adhesive composition of the present invention can be widely used without limitation, sigh as for industrial sheet, particularly protective film, cleaning sheet, reflective sheet, structural pressure sensitive adhesive sheet, photographic pressure sensitive adhesive sheet, lane marking pressure sensitive adhesive sheet, optical pressure sensitive adhesive product, or pressure sensitive adhesive for electronic components. The pressure sensitive adhesive composition can also be applied to equivalent fields using same principles such as multilayered laminate products like general industrial pressure sensitive adhesive sheet products, medical patches, or heat activated pressure sensitive adhesives.

Preferred embodiments of the present invention are illustrated in the following examples to help understanding on the present invention. However, it should be appreciated that those skilled in the art may make modifications and improvements within the spirit and scope of the present invention.

### EXAMPLE 1

### Preparation of Acrylic Copolymers

A monomer mixture of 89.0 parts by weight of 2-ethylhexylacrylate (2-EHA), 9.0 parts by weight of n-butylacrylate (BA), and 2.0 parts by weight of hydroxyethylacrylate (2-HEA) was put into a 1 L reactor equipped with the reflux of nitrogen gas and the cooling system for the regulation of temperature, and 100 parts by weight of ethyl acetate (EAc) was added thereto as a solvent. To remove oxygen therefrom, nitrogen gas was purged for 1 hour, during which the temperature was kept at 55° C., and then 0.05 parts by weight of azobisisobutyronitrile (AIBN) diluted by 50% in ethyl acetate was added thereto as a reaction initiator. The mixture was reacted for 8 hours to obtain the acrylic copolymer.

### Mixing And Coating Process

To 100 parts by weight of the acrylic copolymer prepared above, 3.0 parts by weight of the prepolymer of hexamethylene diisocyanate (HDI) as crosslinking agent and 2.0 parts by weight of dibuthyl phthalate were added. And the mixture was diluted properly, homogeneously mixed, coated on one side of the biaxial oriented polyethylene terephthalate film having the thickness of 38 μm, and dried to obtain an even pressure sensitive adhesive layer having the thickness of 20 μm.

### Laminating Process

A releasing film was laminated on the adhesive layer coated on one side of the above polyethylene terephthalate film, and the obtained product was aged under 40° C. for four days.

The prepared protective film was cut into proper sizes and attached respectively to the surface of triacetyl cellulose (TAC film, Fuji Film Co. of Japan) and the surface of antiglare layer (AG TAC, DNP Co., Ltd. of Japan, surface roughness of 0.3) of a polarizer for evaluation.

### EXAMPLES 2-4 AND COMPARATIVE EXAMPLES 1-5

Except using the component and ratio as shown in Table 1, acrylic copolymers were prepared by the same method as described in Example 1. The unit of Table 1 is parts by weight.

TABLE 1

| | | Example | | | | Comparatives | | | | |
|---|---|---|---|---|---|---|---|---|---|---|
| Acrylic copolymers | | 1 | 2 | 3 | 4 | 1 | 2 | 3 | 4 | 5 |
| Additive | Ester value | 100 | 100 | 100 | 100 | 100 | 100 | 100 | 100 | 100 |
| D950 | 289-299 | 2 | — | — | — | — | 0.1 | 15 | — | — |
| TOTM | 303-311 | — | 2 | — | — | — | — | — | — | — |
| DBP | 400-406 | — | — | 3 | — | — | — | — | — | — |
| ATBC | 552-560 | — | — | — | 5 | — | — | — | — | — |
| C-100 | 147-161 | — | — | — | — | — | — | — | 2 | — |
| PEG | 15 | — | — | — | — | — | — | — | — | 2 |

| | | | | | | | | | |
|---|---|---|---|---|---|---|---|---|---|
| HDI | 3.0 | 3.0 | 3.0 | 3.0 | 3.0 | 3.0 | 3.0 | 3.0 | 3.0 |

D950: Bis(2-butoxyethyl) phthalate + preparation TOTM: Trioctyl trimellitate DBP: Dibutyl phthalate ATBC: Acetyl tributyl citrate C-100: produced by New Japan Chemical Co., Ltd. PEG: Polyethylene glycol (molecular weight of 1000)

Peel strength, wettability, and endurance reliability of the protective films prepared in Examples 1 to 4 and Comparative Examples 1 to 5 were examined by the following methods, and the results are shown in Table 2.

### A. 180° Peel Strength

The protective films prepared in Examples 1 to 4 and Comparative Examples 1 to 5 were adhered to the surface of triacetyl cellulose (TAC, Fuji Film Co. of Japan) and the surface of an antiglare layer (AG, DNP Co., Ltd. of Japan) of a polarizer by a roller of 2 kg, according to JIS Z 0237. And the samples were left under temperature of 23° C. and relative humidity of 65% condition for 24 hours, and temperature of 70° C. for 100 hours. Then the peel strength was measured by using a tensile testing machine at the angle of 180 and the separation speed of 0.3 m/min and 30.0 m/min.

### B. Wettability

The protective films prepared in Examples 1 to 4 and Comparative Examples 1 to 5 were adhered to the surface of an antiglare layer (AG, DNP Co., Ltd. of Japan) of a polarizer of 25 mm by 250 mm by a roller of 2 kg, according to JIS Z 0237. And the protective films were left under temperature of 23° C. and relative humidity of 65% condition for 24 hours, then peeled by hands and adhered again. The wettability was measured as the time of adhering the surface of pressure sensitive adhesive. And the wettability was discriminated by whether bubbles generated or not after the autoclave process under the temperature of 75° C. and pressure of 5 kg/cm2 for 90 minutes after the protective films were adhered to the surface of an antiglare layer (AG, DNP Co., Ltd. of Japan) of a polarizer of 250 mm by 250 mm by a roller of 2 kg.

### C. Endurance Reliability

The polarizer samples of 200 mm by 200 mm (AG, DNP Co., Ltd. of Japan) adhered by the protective films prepared in Examples 1 to 4 and Comparative Examples 1 to 5 were observed whether bubbles or edge lifting happened under the condition of high temperature (80° C., 1000 hours) and the condition of high temperature and humidity (60° C., 90% R.H., 1000 hours). Then the endurance reliability was measured by the following evaluation criteria.

### Evaluation Criteria

◯ No bubbles or edge lifting was observed

ΔA few bubbles or edge lifting were observed

x A large amount of bubbles or edge lifting was observed

TABLE 2

| | | | | | | | | | Heat resistance | |
|---|---|---|---|---|---|---|---|---|---|---|
| | Endurance reliability | | Wettability | | Initial peel strength | | | | peel strength | |
| | Heat | Heat and humid | time | | 0.3 m/min | | 30 m/min | | 0.3 m/min | |
| | resistance | resistance | (sec) | Bubbles | TAG | AG | TAG | AG | TAG | AG |
| Example 1 | ∘ | ∘ | 10 | x | 8.9 | 8.5 | 110 | 100 | 11.7 | 12.5 |
| Example 2 | ∘ | ∘ | 9 | x | 9.1 | 9.0 | 115 | 102 | 12.0 | 12.7 |
| Example 3 | ∘ | ∘ | 9 | x | 11.0 | 9.4 | 95 | 93 | 12.9 | 13.9 |
| Example 4 | ∘ | ∘ | 8 | x | 10.0 | 9.2 | 90 | 84 | 12.5 | 13.0 |
| Comparative 1 | ∘ | ∘ | 20 | ∘ | 12.0 | 11.9 | 171 | 135 | 14.2 | 15.9 |
| Comparative 2 | ∘ | ∘ | 17 | ∘ | 11.5 | 11.4 | 160 | 132 | 13.7 | 15.0 |
| Comparative 3 | ∘ | x | 8 | x | 4.2 | 4.0 | 70 | 65 | 6.5 | 6.0 |
| Comparative 4 | ∘ | ∘ | 10 | x | 5.3 | 6.1 | 99 | 101 | 7.6 | 8.0 |
| Comparative 5 | x | x | 8 | x | 3.6 | 2.3 | 147 | 122 | 8.8 | 5.4 |

As shown in Table 2, the protective film using the acrylic pressure sensitive adhesive composition of the Example 1 to 4 comprising a plasticizer having an ester value of 200 or more according to the present invention has an excellent endurance reliability, an excellent wettability to the surface of an antiglare layer, without any considerable change of adhesive properties, comparing to Comparatives 1 to 5. And it is shown that the protective film has an excellent high-rate release property.

Those skilled in the art will appreciate that the concepts and specific embodiments disclosed in the foregoing description may be readily utilized as a basis for modifying or designing other embodiments for carrying out the same purposes of the present invention. Those skilled in the art will also appreciate that such equivalent embodiments do not depart from the spirit and scope of the invention as set forth in the appended claims.

### INDUSTRIAL APPLICABILITY

The acrylic pressure sensitive adhesive composition of the present invention has an excellent wettability to the surface of an adhered article with surface unevenness, has an excellent endurance reliability, transparency, and stain resistance of adhered article, and has a high-rate release property by comprising a compound having an ester value of 200 or more.

1. Acrylic pressure sensitive adhesive composition comprising:
a) acrylic copolymers; and
b) a compound having an ester value of 200 or more.

2. The acrylic pressure sensitive adhesive composition of claim 1, wherein the composition comprises 0.5 to 10 parts by weight of the compound having an ester value of 200 or more based on 100 parts by weight of the acrylic copolymers.

3. The acrylic pressure sensitive adhesive composition of claim 1, wherein the acrylic copolymers comprise:
i) 90-99.9 parts by weight of (meth) acrylic acid ester monomers having alkyl group of 1-12 carbon atoms; and
ii) 0.1 to 10 parts by weight of vinyl monomers, and/or acrylic monomers having cross-linkable functional groups.

4. The acrylic pressure sensitive adhesive composition of claim 3, wherein the (meth)acrylic add ester monomers having alkyl group of 1-12 carbon atoms are at least one selected from the group consisting of methyl (meth)acrylate, ethyl (meth)acrylate, n-propyl (meth)acrylate, isopropyl (meth)acrylate, n-butyl (meth)acrylate, t-butyl (meth)acrylate, sec-butyl (meth)acrylate, pentyl (meth)acrylate, 2-ethylbutyl (meth)acrylate, 2-ethylhexyl (meth)acrylate, n-octyl (meth)acrylate, isooctyl (meth)acrylate, and isononyl (meth)acrylate.

5. The acrylic pressure sensitive adhesive composition of claim 3, wherein the vinyl monomers and/or acrylic monomers having cross-linkable functional groups are at least one selected from the group consisting of 2-hydroxyethyl (meth)acrylate, 2-hydroxypropyl (meth)acrylate, 4-hydroxybutyl (meth)acrylate, 6-hydroxyhexyl (meth)acrylate, 2-hydroxyethyleneglycol(meth)acrylate, 2-hydroxypropyleneglycol(meth)acrylate, (meth)acrylic acid, maleic add, fumaric add, acrylamide, N-vinyl pyrrolidone, and N-vinyl caprolactam.

6. The acrylic pressure sensitive adhesive composition of claim 3, wherein the acrylic copolymers further comprise the vinyl monomer of the following formula (1): 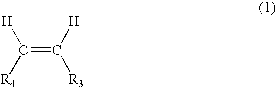
wherein,
R4 represents hydrogen or alkyl,
R3 represents cyano, phenyl unsubstituted or substituted with alkyl, acetyloxy, or CORS, wherein R5 represents amino, or glycidyloxy unsubstituted or substituted with alkyl.

7. The acrylic pressure sensitive adhesive composition of claim 1, wherein the compound having an ester value of 200 or more is at least one selected from the group consisting of dibutyl phthalate, trioctyl trimellitate, bis-(2-butoxy ethyl) phthalate, diisononyl adipic acid, bis-(2-butoxyethyl) adipic add, and acetyltributyl citrate.

8. The acrylic pressure sensitive adhesive composition of claim 1, wherein the acrylic pressure sensitive adhesive composition further comprises crosslinking agent.

9. The acrylic pressure sensitive adhesive composition of claim 8, wherein the crosslinking agent is at least one selected from the group consisting of isocyanates, epoxys, aziridines, or metal chelates.

10. The acrylic pressure sensitive adhesive composition of claim 8, wherein the composition comprises 0.1 to 10 parts by weight of crosslinking agent based on 100 parts by weight of the acrylic copolymers.

11. The acrylic pressure sensitive adhesive composition of claim 1, wherein the acrylic pressure sensitive adhesive composition further comprises at least one additives selected from the group consisting of tackifiers, acrylic low molecular weight substances, epoxy resins, curing agents, UV stabilizers, antioxidants, coloring agents, reinforcing agents, fillers, antifoaming agents, blowing agents, and organic salts.

12. The acrylic pressure sensitive adhesive composition of claim 1, wherein the acrylic pressure sensitive adhesive composition has crosslinking density of 90% or more.

13. A protective film comprising:
a substrate; and an adhesive layer comprising the acrylic pressure sensitive adhesive composition of claim 1.

14. The protective film of claim 13, wherein the thickness of the substrate is 5-500 μm, and the thickness of the adhesive layer is 2-100β m.

15. A polarizer comprising: a polarizing film or a polarizing device; and
the protective film of claim 13.

16. A liquid crystal display comprising liquid crystal display panel in which the polarizer of claim 15 is adhered onto one side or both sides of the liquid crystal cell.
